(19) United States
(12) Patent Application Publication
(10) Pub. No.: US 2013/0089019 A1
(43) Pub. Date: Apr. 11, 2013

(54) APPARATUS AND METHOD FOR MULTICASTING VIDEO IN REAL-TIME

(71) Applicants: Eun Jeong CHOI, Daejeon (KR); Chang Seok Bae, Daejeon (KR); Jeun Woo Lee, Daejeon (KR)

(72) Inventors: Eun Jeong CHOI, Daejeon (KR); Chang Seok Bae, Daejeon (KR); Jeun Woo Lee, Daejeon (KR)

(73) Assignee: Electronics and Telecommunications Research Institute, Daejeon (KR)

(21) Appl. No.: 13/606,138

(22) Filed: Sep. 7, 2012

(30) Foreign Application Priority Data
Oct. 10, 2011 (KR) 10-2011-0103253

(51) Int. Cl. H04H 20/71

(52) U.S. Cl. 370/312

(57) ABSTRACT

Disclosed are an apparatus for multicasting a video in real-time photographed by a portable terminal. An apparatus for multicasting a video in real-time, includes: a target selector selecting receiving terminals which will receive the video; and a video multi-caster provided in a portable terminal and multi-casting the video to selected receiving terminals through a multicasting server such that the video is real-time multicasted for every selected receiving terminal. A user may multicast a currently photographed video in a manner of simultaneously real-time streaming the video to a plurality of users.

### CROSS-REFERENCE TO RELATED APPLICATIONS

This application claims priority to and the benefit of Korean Patent Application No. 10-2011-0103253 filed in the Korean Intellectual Property Office on Oct. 10, 2011, the entire contents of which are incorporated herein by reference.

### TECHNICAL FIELD

The present invention relates to an apparatus and a method for multicasting a video in real-time, and more particularly, to an apparatus for multicasting a video photographed by a portable terminal in real-time.

### BACKGROUND ART

A current technology of synchronizing video contents transmits a stored video file to a server and then sends the stored video file to user terminals. To send a video stored in a user terminal to another user terminal, the stored video may be sent using a function of an MMS, a mail, and the like.

According to the related art, to show a video photographed by the user terminal to another person, stored files need to be sent after photographing the video or to be sent to only one person through a video phone call.

In the meantime, as another example, an video phone call service such as face time of iPhone can transmit and output the video as one-to-one correspondence, but cannot support 1:N transmission.

### SUMMARY OF THE INVENTION

The present invention has been made in an effort to provide an apparatus for streaming and multicasting a video photographed by a portable terminal in real-time, and a method thereof.

An exemplary embodiment of the present invention provides an apparatus for multicasting a video in real-time, including: a target selector selecting receiving terminals which will receive the video; and a video multi-caster provided in a portable terminal and multi-casting the video to the selected receiving terminals through a multicasting server such that the video is real-time multicasted for every selected receiving terminal.

The target selector may include: a querying unit querying first terminals already knowing terminal information which will receive the video; a response message collecting unit collecting a response message to the query for a preset time; and a terminal selecting unit interpreting the collected response message and selecting receiving terminals of the first terminals which will receive the video. The querying unit may query about whether to receive the video to second terminals to meet a preset reference as a terminal not previously knowing the terminal information, and the terminal selecting unit further includes a terminal registering unit registering a terminal of the second terminals allowing reception of the video. The querying unit may be located within a communicable distance with the multicasting server based on the reference.

The apparatus for multicasting a video in real-time may further include a video photographer included in the portable terminal and photographing the video, and the video multi-caster uses a photographed video or a video which starts to be photographed as a target of the multi-casting.

The target selector may use a terminal of which a user is connected to a human network formed through a social network service (SNS) accesses as a query target terminal querying whether to receive the video.

The video multi-caster may include: a video buffering unit buffering a photographed video or a video which starts to be photographed; and a video transmitting unit transmitting the buffered video to the multicasting server such that multi-casting is performed through the multicasting server simultaneously with buffering.

The querying unit may transmit a message with the query the first terminal such that a receiver recognizes the message immediately after receiving the message in a push message form.

The apparatus for multicasting a video in real-time may further include: a terminal information requester requesting terminal information of the fourth terminal to the third terminal when receiving recommendation for a fourth terminal from a third terminal receiving or having received the video; and a target adder adding the fourth terminal to a target to receive video according to whether the fourth terminal receives the video when receiving the terminal information of the fourth terminal.

Another exemplary embodiment of the present invention provides a method for real-time multicasting a video, including: selecting receiving terminals which will receive the video; and multi-casting the video to selected receiving terminals through a multicasting server such that the video is real-time multicasted for every selected receiving terminal.

The selecting of receiving terminals which will receive the video may include: querying first terminals already knowing terminal information which will receive the video; collecting a response message to the query for a preset time; and interpreting the collected response message and selecting receiving terminals of the first terminals which will receive the video. The querying of first terminals already knowing terminal information which will receive the video may include querying second terminals to meet a preset reference whether to receive the video to as a terminal not previously knowing the terminal information, and the selecting of receiving terminals which will receive the video may include registering a terminal of the second terminals allowing reception of the video. The querying of first terminals may be located within a communicable distance with the multicasting server based on the reference.

The method for real-time multicasting a video may further include photographing the video using the portable terminal, and the multi-casting the video uses a photographed video or a video which starts to be photographed as a target of the multi-casting.

The selecting of the receiving terminals for real-time multicasting a video uses a terminal of which a user is connected to a human network is formed through a social network service (SNS) that accesses as a query target terminal querying whether to receive the video.

The multi-casting the video may include buffering the photographed video or the video which starts to be photographed in the portable terminal; and transmitting the buffered video to the multicasting server such that multi-casting is performed through the multicasting server simultaneously with buffering.

The querying about whether to receive the video may transmit a message with a query to the first terminal such that a receiver recognizes the message immediately after receiving the message in a push message form.

The method for real-time multicasting a video may further include: requesting terminal information of the fourth terminal to the third terminal when receiving recommendation for a fourth terminal from a third terminal receiving or having received the video; and adding the fourth terminal to a target to receive video according to whether the fourth terminal receives the video when receiving the terminal information of the fourth terminal.

According to exemplary embodiments of the present invention, it is possible to real-time stream and multi-cast a video photographed by a portable terminal, which achieves following effects by real-time streaming and multi-casting a video photographed by a portable terminal. First, the user may multicast a currently photographed video in a manner of simultaneously real-time streaming the video to a plurality of users. The user may simultaneously share various information with friends, acquaintances, and the like through a video. Second, the user may vividly and simultaneously transfer a field situation to a plurality of users without storing a video.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram schematically illustrating an apparatus for multicasting a video in real-time according to an exemplary embodiment of the present invention.

FIGS. 2A and 2B is a block diagram specifically illustrating an internal configuration of the apparatus for multicasting a video in real-time shown in FIG. 1.

FIGS. 3A and 3B is a block diagram schematically illustrating a configuration added to the apparatus for multicasting a video in real-time shown in FIG. 1.

FIG. 4 is a block diagram schematically illustrating a real-time streaming service system according to an exemplary embodiment of the present invention.

FIG. 5 is a block diagram specifically illustrating an internal configuration of the real-time streaming service system shown in FIG. 4.

FIG. 6 is a flowchart illustrating an exemplary embodiment of an video transmission process using a real-time streaming service system shown in FIGS. 4 and 5.

FIG. 7 is a block diagram schematically illustrating the real-time streaming service system according to another exemplary embodiment of the present invention.

FIG. 8 is a block diagram specifically illustrating an internal configuration of the real-time streaming service system shown in FIG. 7.

FIG. 9 is a flowchart illustrating an exemplary embodiment of an video transmission process using the real-time streaming service system shown in FIGS. 7 and 8.

FIG. 10 is a flowchart schematically illustrating a method for real-time multicasting video according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiments of the present invention are described hereafter, the spirit of the present invention is not limited thereto and may be changed and modified in various ways by those skilled in the art.

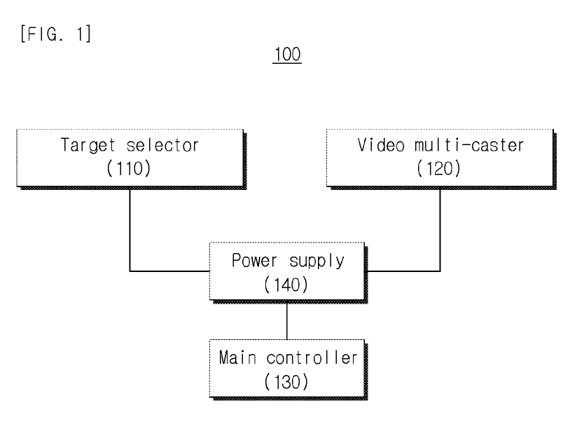

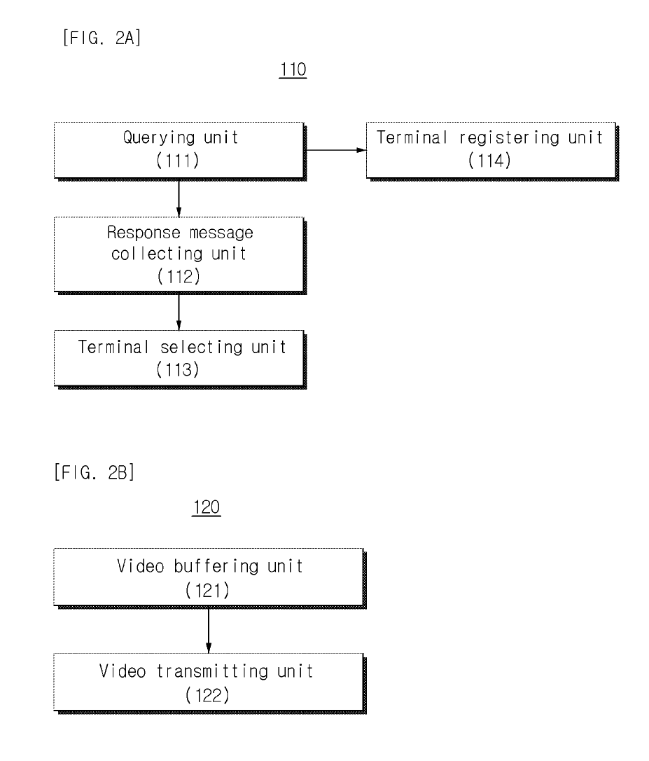

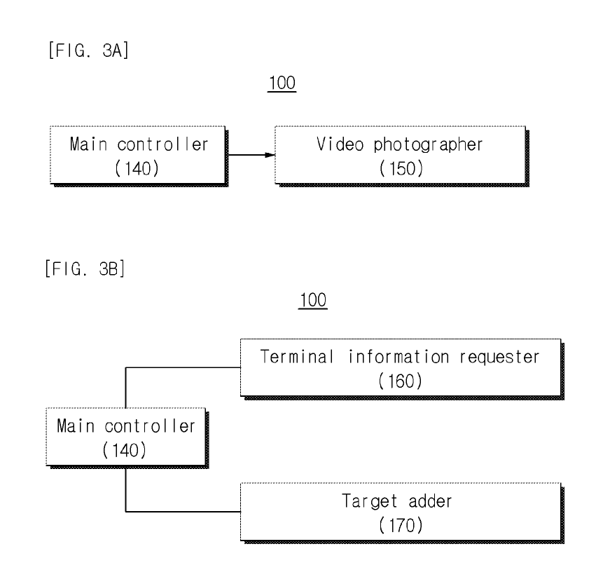

FIG. 1 is a block diagram schematically illustrating an apparatus for multicasting a video in real-time according to an exemplary embodiment of the present invention. FIGS. 2A and 2B is a block diagram specifically illustrating an internal configuration of the apparatus shown in FIG. 1. FIGS. 3A and 3B is a block diagram schematically illustrating a configuration added to the apparatus shown in FIG. 1. Hereinafter, the apparatus for multicasting a video in real-time according to an exemplary embodiment of the present invention will be described with reference to FIG. 1 to FIG. 3B.

The apparatus 100 for multicasting a video in real-time is provided in a portable terminal, which is a device for real-time streaming and multi-casting a video photographed by the portable terminal.

The apparatus 100 multi-casts a video photographed by the portable terminal to other terminals based on a social network. The apparatus 100 selects a terminal which will receive a video for real-time multicasting the video, transmits a message to the selected terminal, and determines whether to provide in real-time a streaming service to a corresponding terminal according to an ACK message. If the video is photographed, the apparatus 100 provides a real-time streaming service to a target terminal to receive video through a server with a push message.

A target selector 110 functions to select receiving terminals which will receive the video. The target selector 110 may use a terminal of which a user is connected to a human network is formed through a social network service (SNS) that accesses as a query target terminal querying whether to receive the video. That is, a terminal associated with the user through a multicasting server based on the social network may be used as a query target terminal. The human network means a human relationship, personal connection, or the like.

As shown in FIG. 2A, the target selector 110 may include a querying unit 111, a response message collecting unit 112, and a terminal selecting unit 113. The querying unit 111 functions to query first terminals already knowing terminal information whether to receive the video. The querying unit 111 may transmit a message with a query to the first terminal such that a receiver recognizes the message immediately after receiving the message in a push message form. The response message collecting unit 112 functions to collect a response message to the query for a preset time. The terminal selecting unit 113 functions to interpret the collected response message and select receiving terminals of the first terminals which will receive the video.

The querying unit 111 may query second terminals to meet a preset reference whether to receive the video as a terminal not previously knowing the terminal information. The target selector 110 may further include a terminal registering unit 114 in consideration of this point. The terminal registering unit 114 functions to register a terminal of the second terminals allowing reception of the video. The first terminal means a terminal which persons (friend, family, and the like) communicating with each other at any time access, and the second terminal means a terminal which acquaintances communicating with each other occasionally access. In the meantime, the querying unit 111 may be located within a communicable distance with the multicasting server based on the reference.

The video multi-caster 120 functions to multi-cast a video to selected receiving terminals through a multicasting server such that the video is real-time multicasted for every selected receiving terminal.

As shown in FIG. 2B, the video multi-caster 120 may include a video buffering unit 121 and a video transmitting unit 122. The video buffering unit 121 functions to buffer a photographed video or a video which starts to be photographed. The video transmitting unit 122 functions to transmit the buffered video to the multicasting server such that multi-casting is performed through the multicasting server simultaneously with buffering.

The power supply 130 functions to supply power to respective constituent elements included in the apparatus 100.

A main controller 140 functions to control an overall operation of the respective constituent elements included in the apparatus 100.

As shown in FIG. 3A, the apparatus 100 may further include a video photographer 150. The video photographer 150 functions to photograph the video. In this case, the video multi-caster 120 may use a photographed video or a video which starts to be photographed as a target of multi-casting.

As shown in FIG. 3B, the apparatus 100 may further include a terminal information requester 160 and a target adder 170. When receiving recommendation for a fourth terminal from a third terminal receiving or having received the video, the terminal information requester 160 functions to request terminal information of the fourth terminal to the third terminal. When receiving the terminal information of the fourth terminal, the target adder 170 functions to add the fourth terminal to a target to receive video according to whether the fourth terminal receives the video.

Hereinafter, an exemplary embodiment of the apparatus 100 will be described with reference to FIGS. 1 to 3B. Hereinafter, an exemplary embodiment relates to a real-time streaming service technology using a camera of a social network based terminal as framework for multicasting in real-time of a social network based portable terminal.

An object of the present invention is to provide an apparatus for sending a video photographed by a portable terminal to plural users or terminal devices to provide a real-time multicasting without storing the video as a file.

The exemplary embodiment of the present invention performs next steps. In a first step, a user selects a person to send an image of friends or families on a social network. In a second step, the apparatus 100 sends a push alarm message to a selected friend to query whether to real-time receive an image. In a third step, when the user is taking a video, the video is sent to the server in a streaming scheme. Next, in the fourth step, the apparatus 100 sends an image to a terminal of a user have responded that the user will receive the video.

The apparatus 100 may additionally select friends or a family on a social network in the middle of a streaming service. A next procedure sends a push message to query whether to receive the streaming service. When the reception of the streaming service is allowed, the apparatus 100 puts a streaming service into effect.

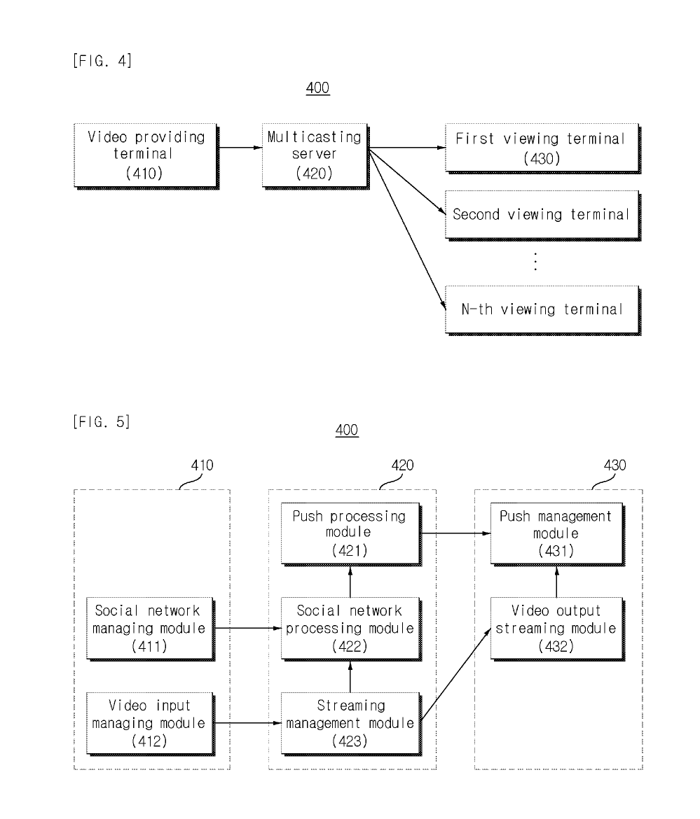

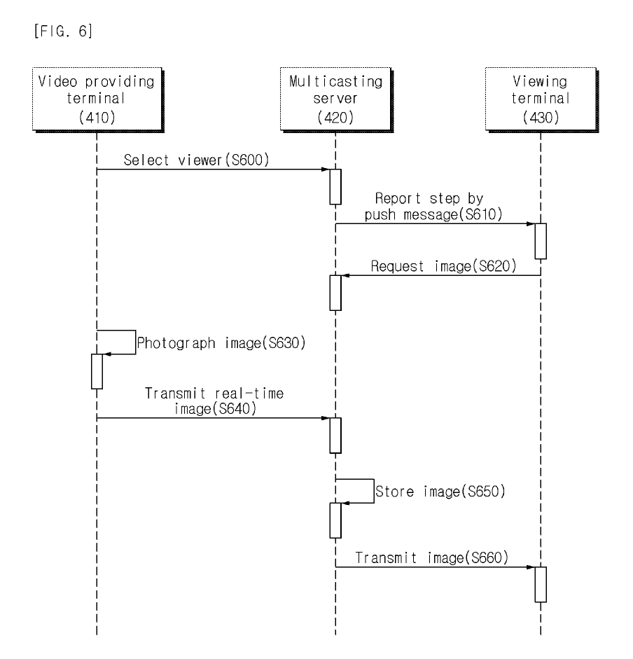

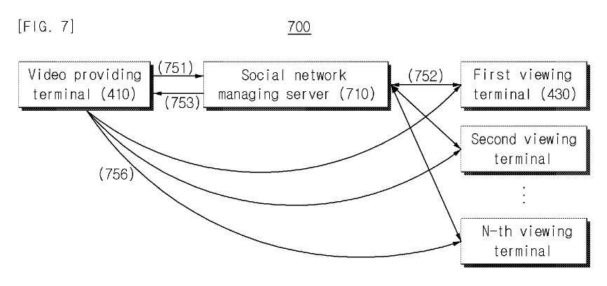

FIG. 4 is a block diagram schematically illustrating a real-time streaming service system according to an exemplary embodiment of the present invention. FIG. 5 is a block diagram specifically illustrating an internal configuration of the system shown in FIG. 4. Hereinafter, the real-time streaming service system will be explained with reference to FIGS. 4 and 5.

As shown in FIG. 4, the real-time streaming service system 400 includes an video providing terminal 410, a multicasting server 420, and a plurality of viewing terminals 430. The video providing terminal 410 functions to provide a photographed video in real-time as a terminal for providing streaming service. The apparatus 100 of FIGS. 1 to 3B is included in the video providing terminal 410. The multicasting server 420 functions to transfer the photographed video to the plurality of viewing terminals 430 associated with the video providing terminal 410 through the social network. The viewing terminalsviewing terminals 430 refer to portable terminals allowing a user to view the photographed video as a terminal for requesting streaming service.

As shown in FIG. 5, the video providing terminal 410 includes a social network managing module 411 and a video input managing module 412. The social network managing module 411 functions to manage a photographed video when the video providing terminal 410 performs a function of a streaming provider to select a viewer receiving the video based on a social network and to report the selected viewer to a server. The social network managing module 411 may be executed before a video is photographed or in the middle of photographing the video to select a viewer. The video input managing module 412 functions to transmit the photographed video to a server while storing (buffering) the video in the video providing terminal 410.

The video providing terminal 410 may receive and view a video multicasted by another terminal. Upon considering this point, the video providing terminal 410 may further include a push management module, a video output streaming module, and the like. Functions performed by the push management module and the video output streaming module will be described below.

As shown in FIG. 5, the multicasting server 420 includes a push processing module 421, a social network processing module 422, and a streaming management module 423. The push processing module 421 recognizes terminals of viewers selected by the video providing terminal 410 and sends a push alarm message to inform whether the viewers view a video in real-time. The social network processing module 422 manages registered video providing terminal 410 information and viewing terminals 430 information. When there is an additional request of the viewing terminalsviewing terminals 430 from the video providing terminal 410 after the real streaming starts, the social network processing module 422 sends a push message to a corresponding viewing terminals 430 to send a photographed video. The streaming management module 423 stores the photographed video provided from the video providing terminal 410 in the server, and simultaneously sends the the photographed video to a viewing terminalsviewing terminals 430. In this case, the viewing terminalsviewing terminals 430 refers to a terminal which is selected by the video providing terminal 410 and naturally agrees to viewing.

As shown in FIG. 5, the viewing terminalsviewing terminals 430 includes a push management module 431 and a video output streaming module 432. The push management module 431 includes a framework for transmitting/receiving a push message, and manages the push message. The video output streaming module 432 requests a video from the multicasting server 420 and outputs the video on a screen. In the meantime, as illustrated above, the viewing terminalsviewing terminals 430 may perform an video providing terminal function.

While viewing the video, a viewing terminal may recommend a corresponding multicasting to another user of a social network. In this case, the multicasting server 420 recognizes a viewing terminal recommending event and sends a recommending message to the video providing terminal 410. If accepting the recommending message, the video providing terminal 410 again sends a push message to the viewing terminal recommended to query whether to view the video. If accepting to view the video, the recommended viewing terminal may receive the video.

FIG. 6 is a flowchart illustrating an exemplary embodiment of an video transmission process using a real-time streaming service system shown in FIGS. 4 and 5. Hereinafter, the video transmission process will be illustrated with reference to FIG. 6.

The video transmission process shown in FIG. 6 includes a viewer selecting step S600, a reporting step by a push message S610, an video requesting step S620, an video photographing step S630, a first video transmitting step S640, an video storing step S650, and a second video transmitting step S660.

The viewer selecting step S600 selects a user viewing an video to be photographed by an video providing terminal 410 on an existing social network such as a messenger or a face-book in which friends or neighbors have a relationship with each other. The reporting step by a push message S610 sends a push message to a viewing terminals 430 selected by the multicasting server 420 to inform a fact that the video providing terminal 410 will send a photographed video. When a viewer agrees to provision of the video, the video requesting step S620 requests the video to the multicasting server 420 through a viewing terminals 430. In the video photographing step S630, an video providing terminal 410 starts photographing a video. The first video transmitting step S640 real-time transmits an video photographed by the video providing terminal 410 to the multicasting server 420 while simultaneously buffering the photographed video on a terminal. In the video storing step S650, the multicasting server 420 stores a received video. The second video transmitting step S660 is performed simultaneously with the video storing step S650. In the second video transmitting step S660, the multicasting server 420 stores a video and simultaneously transmits the video to a viewing terminals 430 having requested the video.

In the meantime, this exemplary embodiment may provide a video transmission service without using the multicasting server 420.

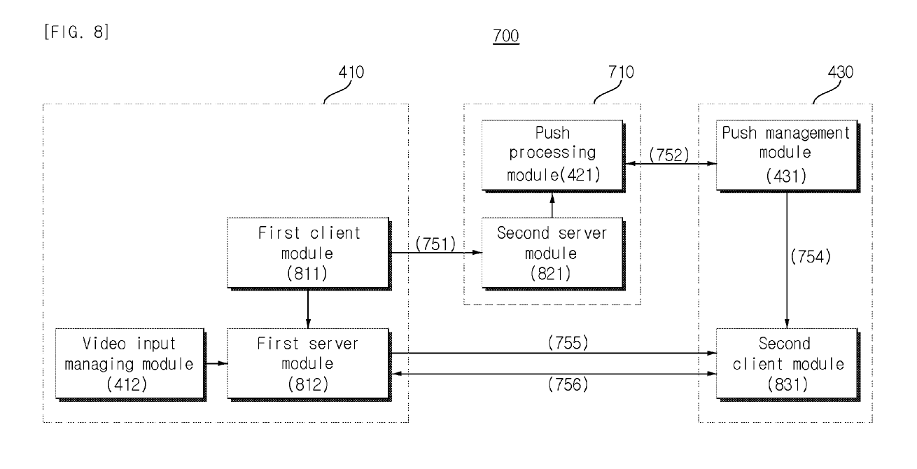

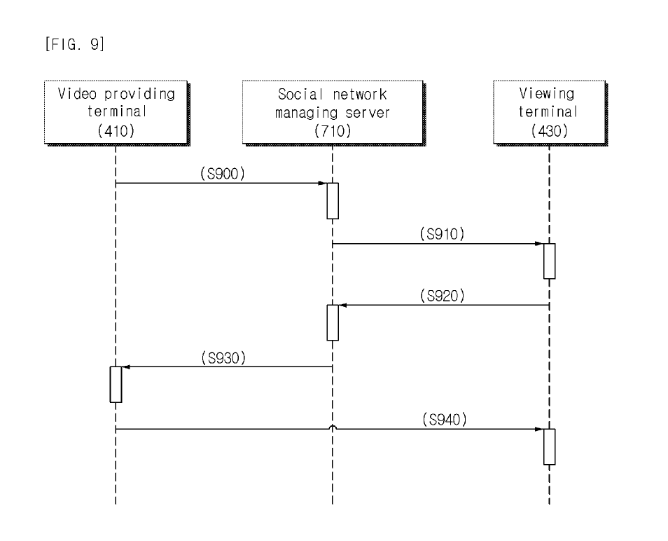

FIG. 7 is a block diagram schematically illustrating the real-time streaming service system according to another exemplary embodiment of the present invention. FIG. 8 is a block diagram specifically illustrating an internal configuration of the real-time streaming service system shown in FIG. 7. Hereinafter, the real-time streaming service system according to another exemplary embodiment of the present invention will be described with reference to FIGS. 7 and 8.

In the real-time streaming service system 700 according to another exemplary embodiment of the present invention, an video providing terminal 410 instead of the multicasting server 420 functions as a streaming server. The video providing terminal 410 selects a viewing target through a social network managing server 710 (751). The social network managing server 710 notifies a push message about whether to receive a streaming service to each viewing terminal and receives a response thereof (752). Next, the social network managing server 710 transmits a list of streaming service requesting terminals to the video providing terminal 410. The terminals for requesting streaming service are under the preparing state for receiving the image (754), the video providing terminal 410 directly connects to a corresponding viewing terminal (755) and provides a video (756).

As shown in FIG. 8, the video providing terminal 410 includes a first client module 811, a video input managing module 412, and a first server module 812. The first client module 811 performs the same function as that of the social network managing module 411 of FIG. 5. The first server module 812 functions to real-time transmit a target video to video requesting terminals.

The social network managing server 710 includes a push processing module 421 and a second server module 821. The second server module 821 performs the same function as that of the social network processing module 422.

The viewing terminals 430 includes a push management module 431 and a second client module 831. The second client module 831 performs the same function as that of the video output streaming module 432.

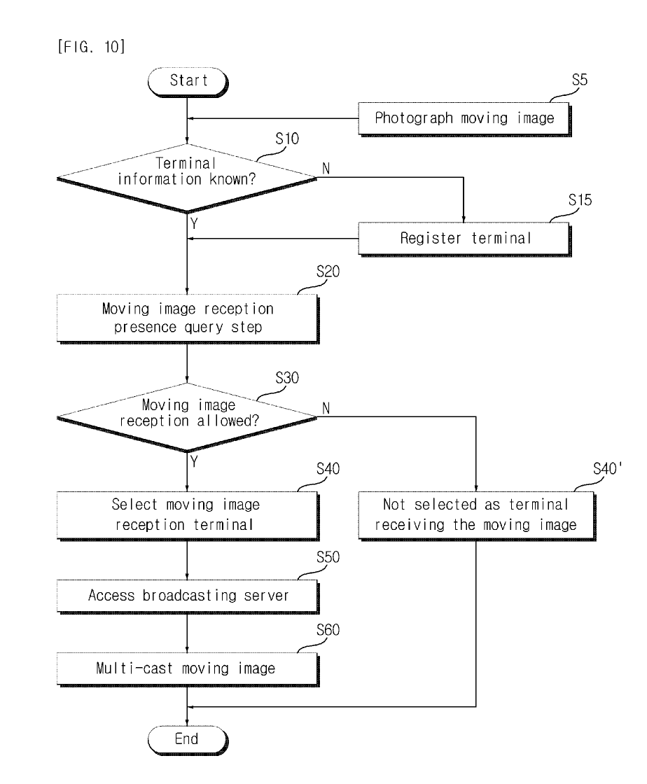

FIG. 9 is a flowchart illustrating an exemplary embodiment of an video transmission process using the real-time streaming service system shown in FIGS. 7 and 8. Hereinafter, the video transmission process will be described with reference to FIG. 9.

The video transmission process shown in FIG. 9 includes a viewer selecting step S900, a streaming service reporting step S910, a determining step whether viewing streaming service S920, a list processing step S930, and a video transmitting step S940.

The viewer selecting step S900 selects a user who will use an video to be photographed by the video providing terminal 410 on a social network. The streaming service reporting step S910 sends a push message to the viewing terminals 430 selected from the social network managing server 710 to report sending by a notice that a video photographed by the video providing terminal 410. The determining step S920 receives a message indicating whether the social network managing server 710 receives a streaming service from the viewing terminals 430. In the list processing step S930, the social network managing server 710 transmits a list of streaming service requesting terminals to the video providing terminal 410. The video transmitting step S940 real-time streams the video photographed by the video providing terminal 410 to a corresponding viewing terminals.

Hereinafter, the following is an explanation of a method for multicasting video in real-time using the apparatus 100 of FIGS. 1 to 3B. FIG. 10 is a flowchart schematically illustrating a method for multicasting video in real-time according to the exemplary embodiment of the present invention. Hereinafter, the method will be described with reference to FIG. 10.

First, a target selector 110 selects receiving terminals which will receive a target to receive video (Hereinafter, target selecting step). The target selector 110 may use a terminal which a user for which a human network is formed through a social network service (SNS) accesses as a query target terminal querying whether to receive the video. The target selecting step may include a query step S20, a response message collecting step and a target selecting step (S30˜S40). In the query step S20, the querying unit 111 queries first terminals already knowing terminal information about whether the first terminals receive the video. The querying unit 111 may transmit a message with a query to the first terminal such that a receiver recognizes the message immediately after receiving the message in a push message form. Next, in the response message collecting step, the response message collecting unit 112 collects a response message to the query for a preset time. In the target selecting step (S30˜S40), the terminal selecting unit 113 interprets the collected response message and selects receiving terminals of the first terminals receiving the video. The selected terminal is a terminal having allowed reception of the video. However, there may be a terminal rejecting the reception of the video. The terminal is not selected as a terminal receiving the video (S40′).

However, there may be a terminal not knowing terminal information among terminals allowing a user to view the video (S10). In the query step S20, in consideration of a fact that there may be a terminal not knowing terminal information among terminals allowing a user to view the video, the querying unit 111 may query second terminals meeting a preset reference about whether to receive the video as a terminal not previously knowing the terminal information. In a terminal registering step, the terminal registering unit 114 registers all of the second terminals (S15). The step S15 may be performed before the query step S20. In the meantime, the terminal registering unit 114 may register terminals having allowed reception of the video of the second terminals. This may be performed at any time after the query step S20. In the meantime, the query step S20 may be located within a distance capable of communicating with a multicasting server based on the reference. After the target selecting step, the video multi-caster 120 multi-casts the video receiving terminal selected from a portable terminal through a multicasting server (S50) such that the video is real-time multicasted for each receiving terminal (video multi-casting step S60).

The video multi-casting step may include a video buffering step and a video transmitting step. In the video buffering step, the video buffering unit 121 buffers a photographed video or a video starting photographing in a portable terminal. In the video transmitting step, the video transmitting unit 122 transmits the buffered video to the multicasting server such that multi-casting is performed through the multicasting server simultaneously with the buffering.

Before the video multi-casting step, the video photographing step may be performed. The video photographing step may be performed at any time before the video multi-casting step. That is, the video photographing step may be performed before the target selecting step, or between the target selecting step and the video multi-casting step. As shown in FIG. 7, the video photographing step may be performed in step S5 or S45. In the video photographing step, the video photographer 150 photographs the video using the portable terminal. In this case, the video multi-casting step may use a photographed video or a video starting photographing.

After the video multi-casting step, a terminal information requesting step and a target adding step may be performed. In the terminal information requesting step, when receiving recommendation for a fourth terminal from a third terminal receiving or having received the video, the terminal information requester 160 requests terminal information of the fourth terminal to the third terminal. Next, in the target adding step, when receiving the terminal information of the fourth terminal, the target adder 170 functions to add the fourth terminal to a target to receive video according to whether the fourth terminal receives the video.

As mentioned above, the apparatus and a method for real-time multicasting a video, described with reference to FIGS. 1 to 10, is applicable to a cloud system, particularly, to a terminal independent personal cloud system.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for multicasting a video in real-time, comprising:
a target selector selecting receiving terminals which will receive the video; and
a video multi-caster provided in a portable terminal and multi-casting the video to the selected receiving terminals through a multicasting server such that the video is real-time multicasted for every selected receiving terminal.

2. The apparatus of claim 1, wherein the target selector includes:
a querying unit querying to first terminals already knowing terminal information already about whether to receive the video;
a response message collecting unit collecting a response message to the query for a preset time; and
a terminal selecting unit interpreting the collected response message and selecting receiving terminals of the first terminals which will receive the video.

3. The apparatus of claim 2, wherein the querying unit queries whether to receive the video to second terminals to meet a preset reference as a terminal not previously knowing the terminal information, and the terminal selecting unit further includes terminal registering unit registering a terminal of the second terminals allowing reception of the video.

4. The apparatus of claim 3, wherein the querying unit is located within a communicable distance with the multicasting server based on the reference.

5. The apparatus of claim 1, further comprising:
a video photographer included in the portable terminal and photographing the video,
wherein the video multi-caster uses a photographed video or a video which starts to be photographed as a target of the multi-casting.

6. The apparatus of claim 1, wherein the target selector uses a terminal which a user for which a human network is formed through a social network service (SNS) accesses as a query target terminal querying whether to receive the video.

7. The apparatus of claim 1, wherein the video multi-caster includes:
a video buffering unit buffering a photographed video or a video which starts to be photographed; and
a video transmitting unit transmitting the buffered video to the multicasting server such that multi-casting is performed through the multicasting server simultaneously with buffering.

8. The apparatus of claim 2, wherein the querying unit transmits a message with a query to the first terminal such that a receiver recognizes the message immediately after receiving the message in a push message form.

9. The apparatus of claim 1, further comprising:
a terminal information requester requesting terminal information of the fourth terminal to the third terminal when receiving recommendation for a fourth terminal from a third terminal receiving or having received the video; and
a target adder adding the fourth terminal to a target to receive video according to whether the fourth terminal receives the video when receiving the terminal information of the fourth terminal.

10. A method for real-time multicasting a video, comprising:
selecting receiving terminals which will receive the video; and
multi-casting the video to the selected receiving terminals through a multicasting server such that the video is real-time multicasted for every selected receiving terminal.

11. The apparatus of claim 10, wherein selecting receiving terminals includes:
querying to first terminals knowing terminal information already about whether to receive the video;
collecting a response message to the query for a preset time; and
interpreting the collected response message and selecting receiving terminals of the first terminals which will receive the video.

12. The method of claim 11, wherein the querying first terminals already knowing terminal information already whether to receive the video includes querying whether to receive the video to second terminals to meet a preset reference as a terminal not previously knowing the terminal information, and
selecting receiving terminals includes registering a terminal of the second terminals allowing reception of the video.

13. The method of claim 10, further comprising:
photographing the video,
wherein the multi-casting the video uses a photographed video or a video which starts to be photographed as a target of the multi-casting.

14. The method of claim 10, wherein the selecting receiving terminals uses a terminal of which a user is connected to a human network is formed through a social network service (SNS) that accesses as a query target terminal querying whether to receive the video.

15. The method of claim 10, further comprising:
requesting terminal information of the fourth terminal to the third terminal when receiving recommendation for a fourth terminal from a third terminal receiving or having received the video; and
adding the fourth terminal to a target to receive video according to whether the fourth terminal receives the video when receiving the terminal information of the fourth terminal.
